(19) United States
(12) Patent Application Publication
(10) Pub. No.: US 2018/0242321 A1
(43) Pub. Date: Aug. 23, 2018

(54) USER TERMINAL, RADIO BASE STATION, RADIO COMMUNICATION METHOD AND RADIO COMMUNICATION SYSTEM

(71) Applicant: NTT DOCOMO, INC., Tokyo (JP)

(72) Inventors: Kazuaki Takeda, Tokyo (JP); Satoshi Nagata, Tokyo (JP); Qin Mu, Beijing (CN)

(73) Assignee: NTT DOCOMO, INC., Tokyo (JP)

(21) Appl. No.: 15/752,191

(22) PCT Filed: Aug. 10, 2016
(86) PCT No.: PCT/JP2016/073591

§ 371 Date: Feb. 12, 2018

(30) Foreign Application Priority Data
Aug. 13, 2015 (JP) 2015-159997

(51) Int. Cl. H04W 72/04

(52) U.S. Cl. CPC H04W 72/0453; H04W 88/02; H04W 72/042

(57) ABSTRACT

The present invention is designed so that even users terminals that are limited to using partial narrow bands in a system band as bands for their use can communicate adequately. According to one aspect of the present invention, a user terminal, in which the band to use is limited to a partial narrow band in a system band, has a receiving section that receives a downlink shared channel that is scheduled in a downlink narrow band, a control section that determines a radio resource for an uplink control channel based on the downlink shared channel, and a transmission section that transmits the uplink control channel in the radio resource, and the control section determines the radio resource for the uplink control channel so that a different radio resource is determined for each downlink narrow band.

### TECHNICAL FIELD

The present invention relates to a user terminal, a radio base station, a radio communication method and a radio communication system in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). In addition, successor systems of LTE (referred to as, for example, “LTE-A” (LTE-Advanced), “FRA” (Future Radio Access), “5G” (5th generation mobile communication system) and so on) are also under study for the purpose of achieving further broadbandization and increased speed beyond LTE.

Now, accompanying the cost reduction of communication devices in recent years, active development is in progress in the field of technology related to machine-to-machine communication (M2M) to implement automatic control of network-connected devices and allow these devices to communicate with each other without involving people. In particular, 3GPP (3rd Generation Partnership Project) is promoting the standardization of MTC (Machine-Type Communication) for cellular systems for machine-to-machine communication, among all M2M technologies (see non-patent literature 2). MTC terminals (MTC UE (User Equipment)) are being studied for use in a wide range of fields such as, for example, electric meters, gas meters, vending machines, vehicles and other industrial equipment.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”
Non-Patent Literature 2: 3GPP TS 36.888 “Study on provision of low-cost Machine-Type Communications (MTC) User Equipments (UEs) based on LTE (Release 12)”

### SUMMARY OF INVENTION

### Technical Problem

From the perspective of reducing the cost and improving the coverage area in cellular systems, among all MTC terminals, low-cost MTC terminals (LC (Low-Cost) MTC UEs) that can be implemented in simple hardware structures have been increasingly in demand. Low-cost MTC terminals can be implemented by limiting the bands to use in the uplink (UL) band and the downlink (DL) to partial narrow bands (NBs) in a system band. A system band is equivalent to, for example, an existing LTE band (for example, 20 MHz), a component carrier (CC) and so on.

However, applying an existing resource allocation scheme that is designed based on a system band to resource allocation for uplink control channels (for example, the PUCCH (Physical Uplink Control CHannel)) for MTC terminals may lead to lower spectral efficiency and lower throughput, and therefore it may not be possible to carry out adequate communication.

The present invention has been made in view of the above, and it is therefore an object of the present invention to provide a user terminal, a radio base station, a radio communication method and a radio communication system that allow adequate communication even when user terminals are limited to using partial narrow bands in a system band as bands for their use.

### Solution to Problem

According to one aspect of the present invention, a user terminal, in which the band to use is limited to a partial narrow band in a system band, has a receiving section that receives a downlink shared channel that is scheduled in a downlink narrow band, a control section that determines a radio resource for an uplink control channel based on the downlink shared channel, and a transmission section that transmits the uplink control channel in the radio resource, and, in this user terminal, the control section determines the radio resource for the uplink control channel so that a different radio resource is determined for each downlink narrow band.

### Advantageous Effects of Invention

According to the present invention, even user terminals that are limited to using partial narrow bands in a system band as bands for their use can communicate adequately.

### BRIEF DESCRIPTION OF DRAWINGS

FIG. 1 is a diagram to show an example arrangement of a narrow band in a system band;

FIG. 2 is a diagram to show an example of PDSCH allocation in an MTC terminal;

FIG. 3 is a diagram to show an example of MPDCCH/PDSCH allocation in the event of 3-PRB localized transmission;

FIG. 4A shows an example of allocating PUCCH resources to one PRB at one edge of a narrow band, FIG. 4B shows another example of allocating PUCCH resources to one PRB at one edge of a narrow band, FIG. 4C shows yet another example of allocating PUCCH resources to one PRB at one edge of a narrow band, and FIG. 4D shows an example of allocating PUCCH resources to one PRB at either edge of a narrow band by using hopping;

FIG. 5A is a diagram to show an example of relationship between downlink narrow bands and uplink narrow bands, and FIG. 5B is a diagram to show another example of relationship between downlink narrow bands and uplink narrow bands;

FIG. 6 is a diagram to show an example of a PUCCH resource collision among a plurality of NBs;

FIG. 7A is a diagram to show an example of PUCCH resource allocation according to a third embodiment, and FIG. 7B is a diagram to show another example of PUCCH resource allocation according to the third embodiment;

FIG. 8A is a diagram to show examples of ARO values according to method 1 of the third embodiment, FIG. 8B is a diagram to show other examples of ARO values according to method 1 of the third embodiment, and FIG. 8C is a diagram to show yet other examples of ARO values according to method 1 of the third embodiment;

FIG. 9A is a diagram to show an example of a DL NB hopping pattern for use when repetitious transmission is employed, and FIG. 9B is a diagram to show an example of PUCCH resource allocation that corresponds to FIG. 9A;

FIG. 10 is a diagram to show a schematic structure of a radio communication system according to an embodiment of the present invention;

FIG. 11 is a diagram to show an example of an overall structure of a radio base station according to an embodiment of the present invention;

FIG. 12 is a diagram to show an example of a functional structure of a radio base station according to one embodiment of the present invention;

FIG. 13 is a diagram to show an example of an overall structure of a user terminal according to an embodiment of the present invention; and

FIG. 14 is a diagram to show an example of a functional structure of a user terminal according to an embodiment of the present invention.

### DESCRIPTION OF EMBODIMENTS

Studies are in progress to simplify the hardware structures of low-cost MTC terminals at the risk of lowering their processing capabilities. For example, studies are in progress to lower the peak rate low, limit the transport block size, limit the resource blocks (also referred to as “RBs,” “PRBs” (Physical Resource Blocks), and so on), and limit the RFs to receive, and so on, in low-cost MTC terminals, in comparison to existing user terminals (LTE terminals).

Low-cost MTC terminals may be referred to simply as “MTC terminals.” Also, existing user terminals may be referred to as “normal UEs,” “non-MTC UEs,” and so on.

Unlike existing user terminals, in which the system band (for example, 20 MHz (100 PRBs), one component carrier, etc.) is configured as the upper limit band for use, the upper limit band for use for MTC terminals is limited to a predetermined narrow band (for example, 1.4 MHz (6 PRBs)). Studies are in progress to run such band-limited MTC terminals in LTE/LTE-A system bands, considering the relationship with existing user terminals.

For example, LTE/LTE-A system bands support frequency-multiplexing of band-limited MTC terminals and band-unlimited existing user terminals. Consequently, MTC terminals may be seen as terminals in which the maximum band to be supported is partial narrow bands in a system band, or may be seen as terminals that have the functions for transmitting/receiving in narrower bands than LTE/LTE-A system bands.

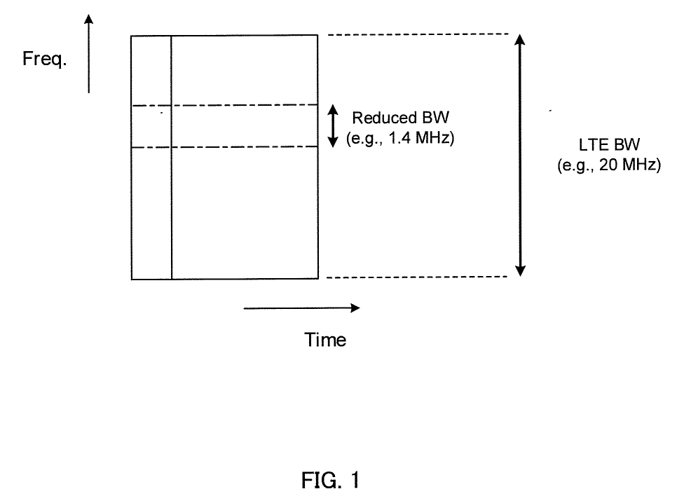

FIG. 1 is a diagram to show an example arrangement of a narrow band in a system band. In FIG. 1, a predetermined narrow band (for example, 1.4 MHz), which is narrower than an LTE system band (for example, 20 MHz), is configured in a portion of a system band. This narrow band is a frequency band that can be detected by MTC terminals.

Note that it is preferable to employ a structure, in which the frequency location of a narrow band that serves as a band for use by MTC terminals can be changed within the system band. For example, MTC terminals should preferably communicate by using different frequency resources per predetermined period (for example, per subframe). By this means, it is possible to achieve traffic offloading for MTC terminals, achieve a frequency diversity effect, and reduce the decrease of spectral efficiency. Consequently, considering the application of frequency hopping, frequency scheduling and so on, MTC terminals should preferably have an RF re-tuning function.

Note that different frequency bands may be used between the narrow bands to use in downlink transmission/reception (DL NBs: Downlink Narrow Bands) and the narrow bands to use in uplink transmission/reception (UL NBs: Uplink Narrow Bands). Also, DL NBs may be referred to as “downlink narrow bands,” and UL NBs may be referred to as “uplink narrow bands.”

MTC terminals receives downlink control information (DCI) by using a downlink control channel that is placed in a narrow band, and this downlink control channel may be referred to as an “EPDCCH” (Enhanced Physical Downlink Control CHannel) or may be referred to as an “MPDCCH” (MTC PDCCH).

Also, MTC terminals receive downlink data by using a downlink shared channel (downlink data channel) that is placed in a narrow band, this downlink shared channel may be referred to as a “PDSCH” (Physical Downlink Shared CHannel) or may be referred to as an “MPDSCH” (MTC PDSCH). Although in the following description, the MPDCCH and the PDSCH will be shown as the downlink control channel and the downlink shared channel for use by MTC terminals, respectively, this is by no means limiting.

Also, an uplink control channel (for example, a PUCCH (Physical Uplink Control CHannel)) and an uplink shared channel (for example, a PUSCH (Physical Uplink Shared CHannel)) for MTC terminals may be referred to as an “MPUCCH” (MTC PUCCH) and an “MPUSCH” (MTC PUSCH), respectively. The above channels are by no means limiting, and any channel that is used by MTC terminals may be represented by affixing an “M,” which stands for MTC, to the existing channel used for the same purpose.

Also, it is possible to provide SIBs (System Information Blocks) for MTC terminals, and these SIBs may be referred to as “MTC-SIBs.”

Now, MTC terminals only support 1.4-MHz narrow bands, and therefore cannot detect downlink control information (DCI) that is transmitted in the wide-band PDCCH. So, it may be possible to allocate downlink (PDSCH) and uplink (PUSCH) resources to MTC terminals by using an MPDCCH.

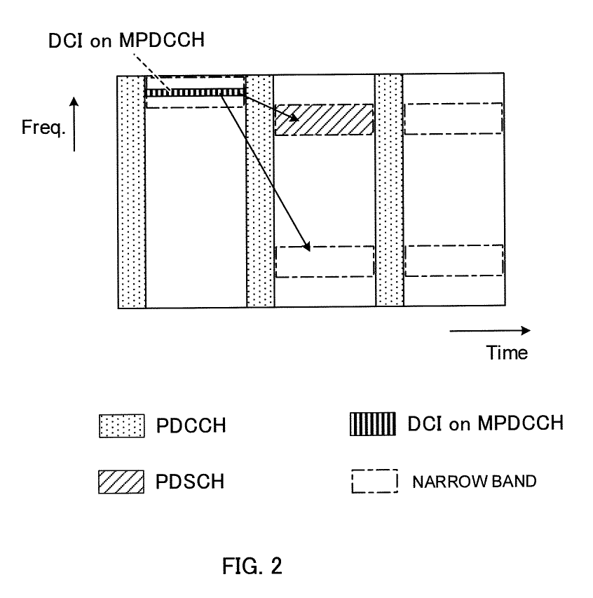

FIG. 2 is a diagram to show an example of PDSCH allocation in MTC terminals. As shown in FIG. 2, first, an MPDCCH is allocated to a predetermined narrow band. Information about the frequency location where the MPDCCH is allocated may be reported in higher layer signaling (for example, RRC signaling, broadcast signals, etc.) or may be configured in user terminals in advance.

As for the method of transmitting the MPDCCH, two types may be possible—namely, distributed transmission and localized transmission. Downlink radio resources where an MPDCCH is allocated are arranged to be distributed in a discontinuous manner in distributed transmission, and are arranged continuously in localized transmission. Furthermore, resources to allocate an MPDCCH are selected from a set of resource elements that can be used (ECCEs (Enhanced Control Channel Elements)).

The MPDCCH contains DCI that relates to the resources to allocate a PDSCH. Candidate radio resources where a PDSCH can be allocated (PDSCH sets) are reported to a user terminal via higher layer signaling, and one of the PDSCH sets is dynamically designated based on the DCI. For example, in FIG. 2, in the next subframe after the MPDCCH is transmitted, a user terminal learns which PDSCH set the user terminal should receive, based on the DCI, and receives the PDSCH accordingly. Note that, the PDSCH may be received in the same subframe the MPDCCH is received.

The user terminal receives the PDSCH in the allocated resources specified by the MPDCCH, and transmits an HARQ-ACK in response to this PDSCH by using a PUCCH (Physical Uplink Control CHannel).

In conventional LTE, regardless of which of the two types of MPDCCH transmission methods is used, the resources to allocate a PUCCH are determined in association with ECCE indices. Furthermore, in the resources where a PUCCH is allocated, the ECCE indices can be shifted based on an ARO (ACK/NACK Resource Offset) field that is reported in downlink control information (DCI).

As described above, PUCCH resources are determined in association with ECCEs. That is, the number of PUCCH resources (resources to use to transmit the PUCCH) changes with the number of ECCEs that are available for use. For example, in the event of localized transmission, assuming that the number of ECCEs per PRB (per MPDCCH) is 4, 8 PUCCH resources are required in 2 PRBs, and 12 PUCCH resources are required in 3 PRBs.

However, an MTC terminal that is limited to using narrow bands as bands for its use does not need this many PUCCH resources. Furthermore, in PRBs that are determined as PUCCH resources, UL signals other than the PUCCH (the PDSCH and so on) cannot be transmitted, in order to reduce the interference against control signals. Consequently, if the conventional PUCCH-resource determining method is used, it is likely to waste PUCCH resources and damage the uplink spectral efficiency.

So, the present inventors have focused on the fact that, in MTC terminals, the number of PRBs that can be actually used is smaller than the number of ECCEs configured in conventional LTE. Focusing on this point, the present inventors have come up with the idea of determining PUCCH resource locations based on PRBs.

Now, embodiments of the present invention will be described below. Although MTC terminals will be shown as an example of user terminals that are limited to using narrow bands as bands for their use, the application of the present invention is not limited to MTC terminals. Furthermore, although 6-PRB (1.4-MHz) narrow bands will be described below, the present invention can be applied to other narrow bands as well, based on the present description.

(Radio Communication Method)

### First Embodiment

According to a first embodiment of the present invention, radio resources for an uplink control channel are specified by using information related to a downlink narrow band (DL NB). To be more specific, PUCCH resources in an uplink narrow band (UL NB) are specified by using PRB indices (for example, 0 to 5) that indicate the PRBs of a downlink shared channel (for example, the PDSCH) scheduled in a downlink narrow band. In MTC terminals, the number of PRB indices is likely to be smaller than the number of ECCE indices conventionally used to determine PUCCH resources, so that, according to the present embodiment, it is possible to avoid reserving unnecessary PUCCH resources.

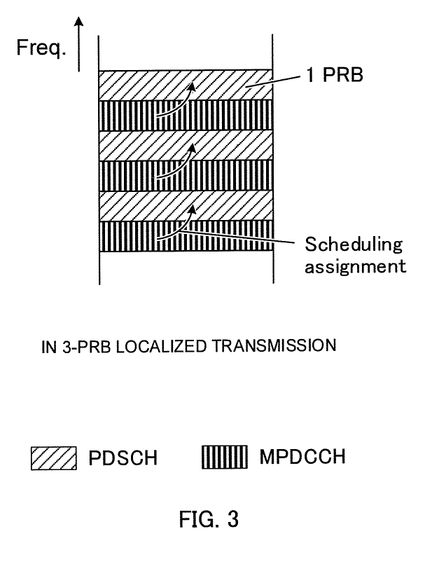

For example, assuming that MTC terminals are limited to using bands of 6 PRBs (1.4 MHz), even if one PDSCH PRB is to be allocated per UE, it is only necessary to allocate maximum 3 PDSCH PRBs. FIG. 3 is a diagram to show an example of MPDCCH/PDSCH allocation in the event of 3-PRB localized transmission.

Referring to FIG. 3, the MPDCCH contains information for PDSCH scheduling assignment. This information for scheduling assignment may include, for example, information that represents the location of PDSCH resources. The information to indicate the location of PDSCH resources may be, for example, a PRB index (for example, one of 0 to 5) within a predetermined narrow band (for example, 6 RBs), or may be a relative frequency offset to the location of MPDCCH resources. Note that a user terminal may implicitly identify the location of PDSCH resources based on the location of MPDCCH resources. For example, the location of PDSCH resources may be judged as being the location where one PRB of frequency is added to the location of MPDCCH resources detected.

An MTC terminal specifies the PRB of a PDSCH received in a predetermined narrow band (PDSCH set). To specify the PRB, for example, a PRB index can be used. Furthermore, the PUCCH resources for transmitting an ACK/NACK in response to the PDSCH can be specified in association with the PRB index of the PDSCH. For example, the PUCCH resources may be determined as a function of the PRB index of the PDSCH.

Note that, when a plurality of PRBs are scheduled, an index to represent one of the multiple PRBs may be used as a PRB index. For example, as a PRB index for determining PUCCH resources, a UE may use at least of one of the index to indicate the minimum PRB among the multiple PRBs, the index to indicate the maximum PRB and a PRB that is different from these.

Assume that, according to the present embodiment, the relationship between the downlink narrow band in which a PDSCH is received and the uplink narrow band in which a PUCCH is transmitted in response to the PDSCH are determined in advance. However, as will be described later with the second embodiment, information about this relationship may be reported to MTC terminals.

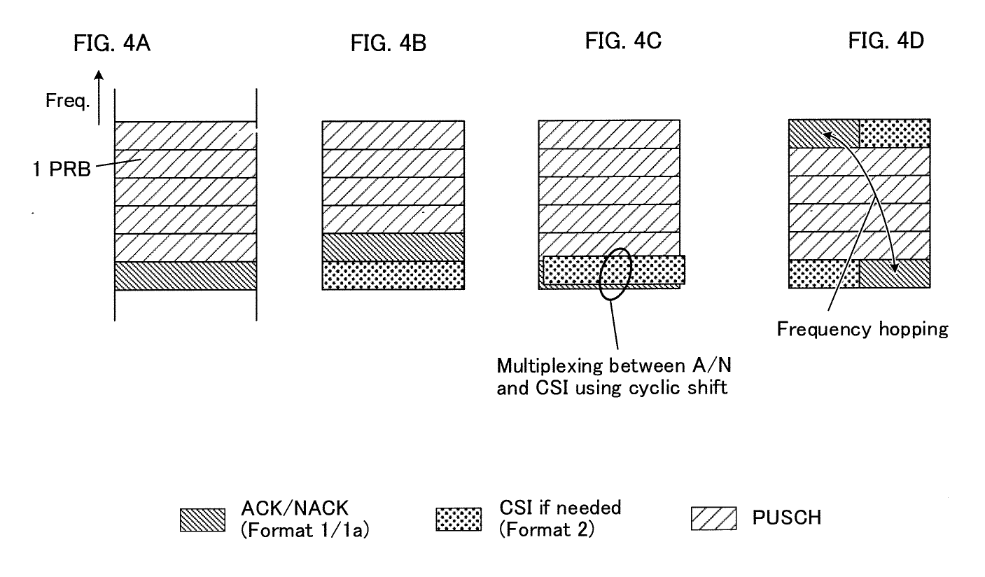

According to the present embodiment, 6 PUCCH resources suffice for MTC terminals, and therefore the PUCCH resources are likely to stay within one PRB. FIG. 4 provide diagrams to show examples of PUCCH resource allocation according to the first embodiment. Note that the radio resources where PUCCH resources are not allocated can be used as PUSCH resources.

FIG. 4A shows an example of allocating PUCCH format 1/1A for an ACK/NACK to one PRB at one edge of a narrow band. While existing user terminals have heretofore determined PUCCH resources based on ECCEs in predetermined regions in a system band (for example, at both edges of a system band), the user terminal of the present embodiment can determine these resources more easily based on the PRB index that specifies the PDSCH received.

The PUCCH resources for an ACK/NACK may be allocated apart from one PRB at an edge of a narrow band. FIG. 4B shows an example, in which PUCCH format 2 for CSI (Channel State Information) is assigned to one PRB at an edge of a narrow band, and in which PUCCH format 1/1A is assigned to one PRB that neighbors this PRB.

Also, the PUCCH resources for an ACK/NACK may be multiplexed on the same resources with other signals. FIG. 4C shows an example, in which PUCCH resources for an ACK/NACK and PUCCH resources for CSI are multiplexed on one PRB at an edge of a narrow band by applying a cyclic shift. In this case, many resources need to be reserved in order to apply a cyclic shift to the CSI, so that it is preferable to reduce the ACK/NACK PUCCH resources based on the present embodiment. Note that the method of multiplexing is by no means limited to cyclic shift, and, for example, orthogonal sequences may be used.

Furthermore, the PUCCH resources for an ACK/NACK and the PUCCH resources for CSI may be subject to frequency hopping within a narrow band. FIG. 4D shows an example in which PUCCH resources are allocated to one PRB at both edges of a narrow band by way of hopping. The hopping may be applied in slot units or in subframe units.

Note that, if a user terminal is commanded to transmit a PUSCH at the timing a PUCCH is transmitted, the user terminal may transmit the contents of the PUCCH (ACK/NACK, CSI and so on) in the PUSCH.

As described above, according to the first embodiment, it is possible to reduce the PUCCH resources for ACKs/NACKs by using PDSCH PRB indices instead of MPDCCH ECCE indices. For example, when there are 3 PRBs as shown in FIG. 3, it has heretofore been necessary to reserve 12 PUCCH resources in conventional LTE (when the number of ECCEs per PRB is 4), but, according to the present embodiment, only 6 PUCCH resource need to be reserved at a maximum even when there are 6 PRBs.

### Second Embodiment

The method of specifying PUCCH resources will be described in greater detail with a second embodiment. According to the second embodiment, a UE determines PUCCH resources based on the relationship between downlink narrow bands (DL NBs) and uplink narrow bands (UL NBs).

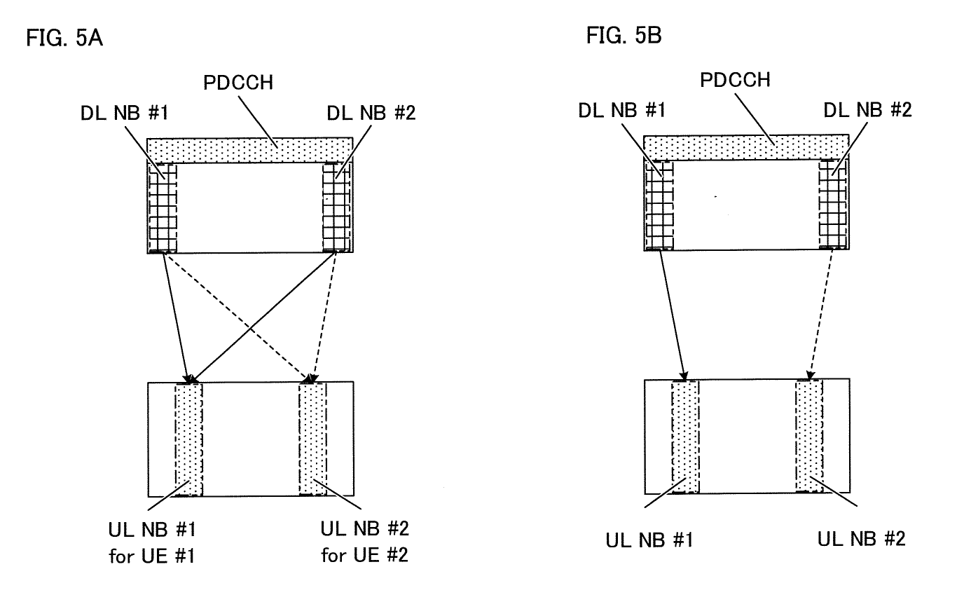

FIG. 5 provide diagrams to show examples of the relationship between downlink narrow bands and uplink narrow bands. Although FIG. 5 assume that a plurality of UL NBs are configured by a radio base station via higher layer signaling (for example, RRC signaling), it is equally possible have these multiple UL NBs memorized in a UE in advance.

In FIG. 5A, a UE (or UE group) is configured to use at least one UL NB as a UL NB for the PUCCH. Information about the UL NBs for the PUCCH may be reported by using, for example, higher layer signaling (for example, RRC signaling) or downlink L1/L2 signaling (for example, DCI), or by combining these.

In FIG. 5A, UE #1 is configured to transmit the PUCCH by using UL NB #1, and UE #2 is configured to transmit the PUCCH by using UL NB #2. In this case, UE #1 feeds back an HARQ-ACK, in UL NB #1, in response to the PDSCH received in either DL NB #1 or DL NB #2. Also, UE #2 feeds back an HARQ-ACK, in UL NB #2, in response to the PDSCH received in either DL NB #1 or DL NB #2. That is, the above-noted information about the UL NBs for the PUCCH may be seen as information to represent the relationship between all downlink narrow bands and one uplink narrow band.

Note that, it is equally possible to configure a plurality of PUCCH UL NBs for a predetermined UE. In this case, this predetermined UE may determine the UL NB for transmitting the PUCCH, from among the multiple UL NBs configured, based on one of higher layer signaling, L1/L2 signaling, channel states and so on, or by combining these.

As shown in FIG. 5A, the configuration to allow a UE (or UE group) to send feedback by using a designated PUCCH makes it possible to improve the spectral efficiency.

Also, in FIG. 5B, a UE (or UE group) determines an UL NB for the PUCCH based on a downlink (for example, PDSCH)-receiving DL NB. This selection may be made based on information about the relationship between downlink narrow bands and uplink narrow bands, and this information about relationship may be reported to a UE by using one of higher layer signaling and L1/L2 signaling, or by combining these. For example, this information about relationship may be reported from radio base stations to user terminals in a cell-specific manner.

In FIG. 5B, UL NB #1 is configured to correspond to DL NB #1, and UL NB #2 is configured to correspond to DL NB #2. In this case, each UE feeds back an HARQ-ACK, in UL NB #1, in response to the PDSCH received in DL NB #1. Also, each UE feeds back an HARQ-ACK, in UL NB #2, in response to the PDSCH received in DL NB #2.

Note that, although FIG. 5B shows an example in which one UL NB corresponds to one DL NB, this is by no means limiting. For example, one UL NB may correspond to a plurality of DL NBs. Also, the number of DL NBs and the number of UL NB may be different (the proportions of DL/UL may vary).

As described above, according to the second embodiment, based on a DL NB (the frequency location of a DL NB) that is received, a UE can adequately identify the UL NB that correspond to the DL NB.

### Third Embodiment

A third embodiment relate to a method of reducing PUCCH resources. First, assuming the case to use narrow bands, problems that arise when determining PUCCH resource nu using conventional methods will be explained.

While the number of PUCCHs that can be multiplexed on one PRB is 12, the number of PDSCHs that can be multiplexed on one NB is 6. That is, ACKs/NACKs for a plurality of NBs can be fed back in one PRB of PUCCHs.

As has been described with the first embodiment, PUCCH resources for transmitting an ACK/NACK in response to a PDSCH can be specified in association with a PRB index ₙ PRB pf the PDSCH. For example, a PUCCH resource index n PUCCH can be found based on following equation 1:

ₙ PUCCH=ₙ PRB+N(1) (Equation 1)

where N(1) is a cell-specific value, and reported, for example, in an MTC-SIB.

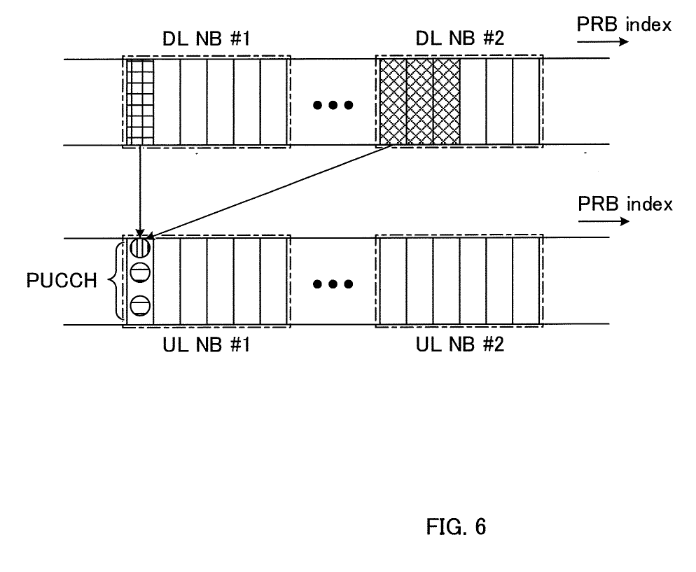

Using an equation like this might lead to collisions of PUCCH resources among a plurality of NBs. For example, a case will be described below, with reference to FIG. 6, where, for example, the minimum PDSCH-allocated PRB index (for example, 0 to 5) is used as an PRB index.

FIG. 6 is a diagram to show an example of a PUCCH resource collision among a plurality of NBs. Here, an example illustrated in which UE #1 is allocated a PDSCH in one PRB (PRB index=0) in DL NB #1, and UE #2 is allocate a PDSCH in 3 PRBs (PRB indices=0 to 2) in DL NB #2. Also, the HARQ feedback in response to the PDSCHs of DL NB #1 and DL NB #2 is sent in UL NB #1.

In FIG. 6, the minimum PDSCH-allocated PRB index is 0 in both DL NB #1 and DL NB #2, so that HARQ-ACKs in response to the PDSCHs are transmitted in the same PUCCH resources in UL NB #1, resulting in a collision of PUCCH resources among these multiple UEs. In this case, adequate downlink HARQ retransmission is not possible, and the downlink throughput decreases.

The present inventors have worked on reducing the above-described collisions, and come up with the idea of applying different offsets on a per DL NB basis and determining corresponding PUCCH resources. According to the third embodiment of the present invention, the radio resources for an uplink control channel (for example, a PUCCH for feeding back an HARQ-ACK in response to a PDSCH) that corresponds to a downlink shared channel scheduled in a downlink narrow band are determined so that different radio resources are determined for each downlink narrow band (resources that do not overlap each other are used).

According to method 1 of the third embodiment, PUCCH resource indices are shifted based on the ARO field that is reported in PDSCH-scheduling downlink control information (DCI). The values indicated by the ARO field are associated with different amounts of shift to be applied to PUCCH resource indices. Information about the relationship between the ARO field and the amount of shift for PUCCH resource indices may be reported by using, for example, higher layer signaling (for example, RRC signaling, a broadcast signal (MTC-SIB), etc.), or may be held in user terminals in advance.

For example, a PUCCH resource index n PUCCH can be found based on following equation 2:

ₙ PUCCH=ₙ PRB+ARO+N(1) (Equation 2)

Method 1 is designed so that ARO field received in a UE (and the amount of shift determined from the ARO field) shows a different value per DL NB.

According to method 2 of the third embodiment, PUCCH resource indices are shifted based on downlink NB-specific offsets (NB-specific offsets). For example, a PUCCH resource index n PUCCH can be found based on following equation 3:

ₙ PUCCH=ₙ PRB+NB-specific offset (Equation 3)

Note that the ARO reported in DCI may be added to equation 3 to provide a PUCCH resource index.

The NB-specific offset may be, for example, an offset that is linked the DL NB's frequency resources, or may be an offset that is linked with the DL NB's frequency hopping pattern (which may be referred to as the “NB pattern”) (and may be referred to as a “hopping pattern-specific offset,” “NB pattern-specific offset,” etc.). This frequency hopping of NBs is under study for use when, for example, transmitting the same signal (transport block) in repetitious transmission (repetition) for coverage enhancement (CE).

According to method 3 of the third embodiment, information about PUCCH resource indices is directly reported, and, based on this information and the ARI (ACK/NACK Resource Indicator), PUCCH resource indices are configured on a dynamic basis. Note that the transmit power control (TPC) field contained in DCI may be re-interpreted for use as an ARI.

Note that, according to method 3, PUCCH resource indices may be associated with PRB indices.

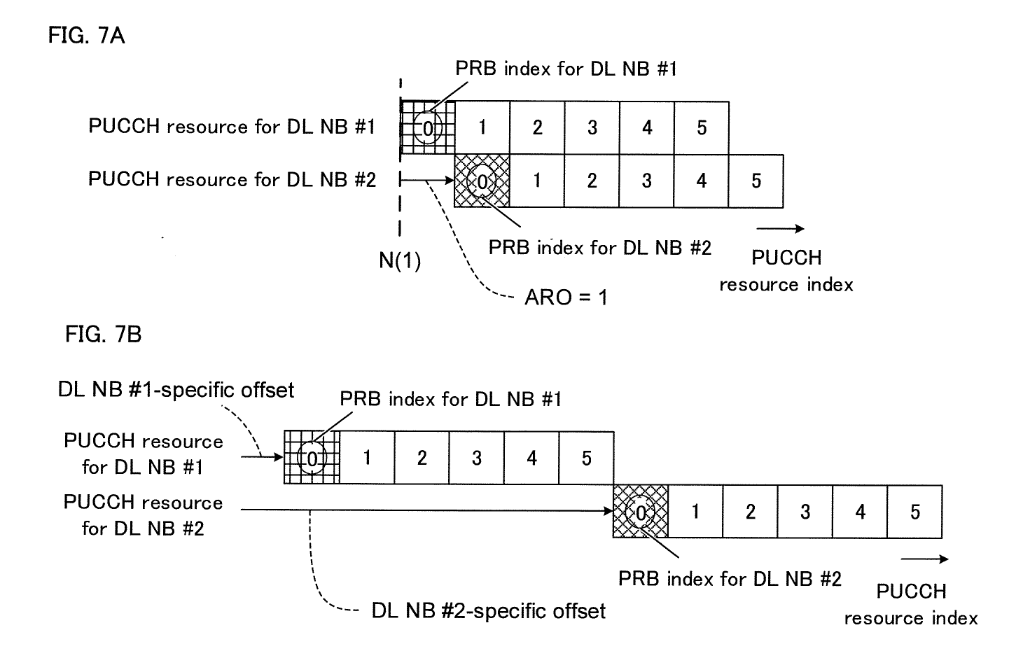

FIG. 7 provide diagrams to show examples of PUCCH resource allocation according to the 3 embodiment. FIG. 7 show the relationship between PDSCH PRB indices for DL NBs and the PUCCH resources to allocate to predetermined UL NBs. FIG. 7A and FIG. 7B correspond to method 1 and method 2, respectively.

In FIG. 7A, the PDCCH in which the PDSCH (PRB index=0) for DL NB #1 is scheduled contains DCI that indicates an ARO=0, and the PDCCH in which the PDSCH (PRB index=0) for DL NB #2 is scheduled contains DCI that indicates an ARO=1. Although equation 2 makes the PRB index of the PDSCH 0 in both DL NB #1 and DL NB #2, the PUCCH resource index of the PDSCH for DL NB #2 can be shifted by 1, so that it is possible to avoid a collision of resources.

Also, in FIG. 7B, six different values are configured for DL NB #1-specific offsets and DL NB #2-specific offsets. Although equation 3 makes the PRB index of the PDSCH 0 in both DL NB #1 and DL NB #2, the PUCCH resource index of the PDSCH for DL NB #2 can be shifted by 6, so that it is possible to avoid a collision of resources.

Note that, according to the third embodiment, PUCCH resources may be determined so that, as shown in FIG. 7B, all the PUCCH resources vary per downlink narrow band (so as to allow no overlap of PUCCH resources), or PUCCH resources may be determined so that, as shown in FIG. 7A, at least part of the PUCCH resources vary per downlink narrow band (so as to prevent at least part of the PUCCH resources from overlapping). In the latter case, the PUCCH resources are determined so that the uplink control channel radio resources to correspond to the same PRB index are one PRB or more different.

Also, by making the amount of shift to apply to a PUCCH resource index between DL NBs greater than the number of PRBs in an NB (for example, 6), it is possible to prevent the PUCCH resources for two DL NBs' PDSCHs from colliding each other, regardless of the PRB index values. That is, the amount of shift that can be determined from the ARO field (method 1), the NB specific-offset (method 2), and information about the PUCCH resource index and/or ARI (method 3) should preferably be configured so that, for a downlink shared channel for a plurality of DL NBs, the uplink control channel radio resources to correspond to the same PRB index are 6 PRBs or more different.

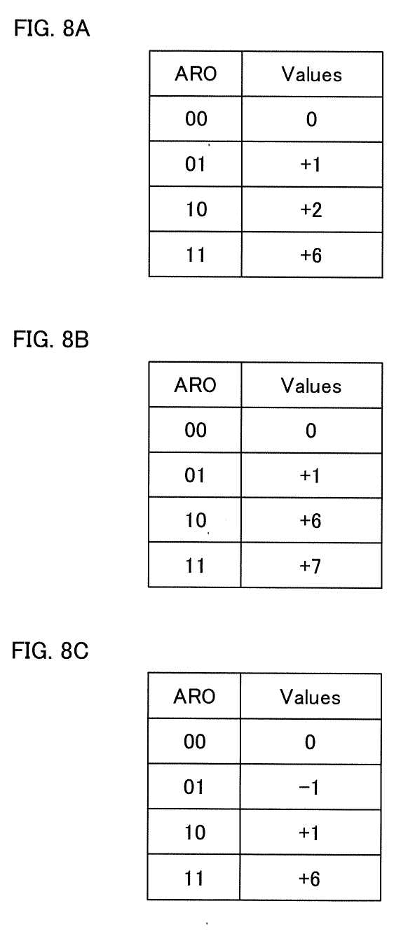

FIG. 8 provide diagram to show examples of ARO values according to method 1 of the third embodiment. Although an ARO is represented with 2 bits here, it is equally possible to represent an ARO with 3 or more bits. As mentioned earlier, it is preferable to include, as a value indicated by an ARO, a value that is equivalent to the number of PRBs in an NB (for example, 6), and, in any of the configurations in FIG. 8, ARO to correspond to “+6” is included.

In FIG. 8A, relatively many values that are smaller than the value that is equal to the number of PRBs in an NB are include (such as “+1,” “+2,” etc.). This configuration enables finer control of PUCCH resources. In FIG. 8B, a value that is greater than the value that is equal to the number of PRBs in an NB is included (“+7”). This configuration can cope with increased PUCCH resources in the future. In FIG. 8C, a negative value (“−1”) is included. This configuration enables further reduction of PUCCH resources.

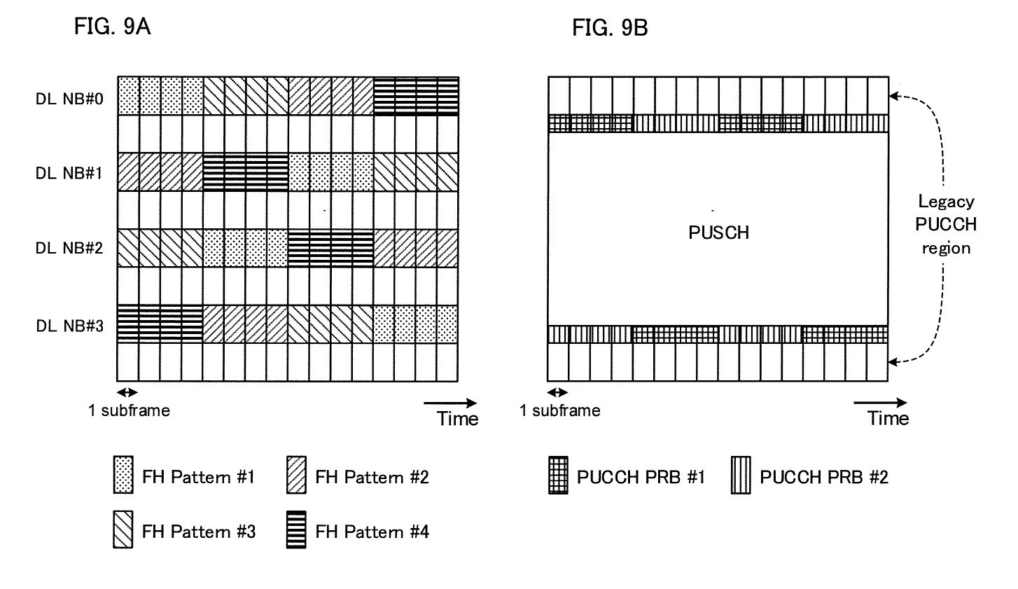

FIG. 4 provide diagrams to show examples of PUCCH resource allocation according to the first embodiment. In this example, repetitious transmission (for example, 4 repetitions, 8 repetitions, 12 repetitions, 16 repetitions, etc.) is applied to both the uplink and the downlink. FIG. 9A shows examples of DL NB hopping patterns for use when repetitious transmission is employed. FIG. 9B shows an example of PUCCH resource allocation that matches FIG. 9A.

FIG. 9A shows frequency hopping patterns in which the narrow band to allocate the PDSCH is changed every predetermined number of subframes (every 4 subframes) among a plurality of narrow bands (DL NBs #0 to #3). In FH pattern #1 in FIG. 9A, the NB to allocate (map) the PDSCH changes every 4 subframes (which goes like, for example, NB #0→NB #2→NB #1→NB #3).

In FIG. 9A, 4 NBs (DL NBs #0 to #3) are configured in an MTC terminal as narrow bands for frequency hopping. Also, frequency hopping (FH) patterns #1 to #4 determined in advance, and configured in the MTC terminal. The information about the DL NBs for hopping patterns, and/or information about the hopping patterns of DL NBs may be reported in higher layer signaling (for example, RRC signaling, a broadcast signal (MTC-SIB), etc.), or may be provided in user terminals in advance.

Note that, FH patterns may be determined based on, for example, cell-specific information. Also, the number of NBs where the PDSCH can be allocated, the above predetermined number and the structure of narrow bands are by no means limited the examples shown in FIG. 9A.

In FIG. 9A, an MTC terminal receives a start index, which indicates the NB where a PDSCH starts being allocated, in an MPDCCH, and specifies the frequency hopping pattern to apply to the PDSCH, from FH patterns #1 to #4, based on the above start index. To be more specific, the MTC terminal receives DCI containing this start index via the MPDCCH. For example, in FIG. 9A, if the MTC terminal receives DCI that contains start index #1 (NB #1) in the leftmost subframe shown in the figure, the MTC terminal specifies FH pattern #2 based on this start index #1.

In FIG. 9B, two PUCCH NB regions are configured, 2 PRBs (PUCCH PRBs #1 and #2) in these regions are shown as PUCCH resources to correspond to the DL NBs of FIG. 9A. Here, PUCCH resources (for example, NBs and/or PRBs) are configured in MTC terminals. Information about the PUCCH resources may be reported via higher layer signaling (for example, RRC signaling, a broadcast signal (MTC-SIB), etc.), or may be provide in user terminals in advance. Note that a plurality of PUCCH resources may be configured.

Referring to FIG. 9B, if six patterns of cyclic shift and three OCCs (Orthogonal Cover Codes) can be used in each PUCCH PRB, given 2 PRBs, a total of 36 PUCCH resources can be used. In this case, for the NB-specific-offset (NB pattern-specific offset) in above equation 3, 0, 9, 18 and 27 may be configured for patterns #1 to #4 (or DL NBs #0 to #3), respectively.

That is, the NB pattern-specific offset can be determined based on the number of PUCCH resources that can be used (the maximum number) and the number of DL NBs. According to this configuration, PUCCH PRB #1 of FIG. 9B is associated with DL NBs #0 and #1, and PUCCH PRB #2 is associated with DL NBs #2 and #3. By this means, it is possible to prevent the resources of PUCCHs that correspond to different DL NB hopping patterns (for example, a PUCCH for transmitting HARQ-ACKs) from colliding.

Note that the NB-specific offset in above equation 3 may be determined based the DL NB in which a PDSCH that has been transmitted in repetitions is received first or last.

Note that information about the parameters to use to determine uplink control channel radio resources (for example, N(1), the NB-specific offset, the NB pattern-specific offset, the PUCCH resource index, and so on) may be reported in higher layer signaling (for example, RRC signaling, a broadcast signal (MTC-SIB), etc.), or may be provided in user terminals in advance. Also, the default values (initial values) of the parameters to use to determine uplink control channel radio resources (for example, the PRB index, N(1), the NB-specific offset, the NB pattern-specific offset, the PUCCH resource index, and so on) may be reported in higher layer signaling (for example, RRC signaling, a broadcast signal (MTC-SIB), etc.), or may be provided in user terminals in advance.

As described above, according to the third embodiment, it is possible to prevent the collisions of PUCCH resources even when UEs use narrow bands, so that it is possible to reduce the decrease of downlink throughput due to downlink HARQ retransmission.

Note that, although examples have been described with the above embodiments where PUCCH resources are specified by using PDSCH PRB indices, these are by no means limiting. For example, it is equally possible to specify PUCCH resources by using MPDCCH ECCE indices, and, in this case, the specification of UL NBs based on DL NB, which has been described with the second embodiment, and the shifting of PUCCH resources, which has been described with the third embodiment, may be applied.

(Radio Communication System)

Now, the structure of the radio communication system according to an embodiment of the present invention will be described below. In this radio communication system, the radio communication methods according to the above-described embodiments of the present invention are employed. Note that the radio communication methods of the above-described embodiments may be applied individually or may be applied in combination. Here, although MTC terminals will be shown as an example of user terminals that are limited to using narrow bands as bands for their use, the present invention is by no means limited to MTC terminals.

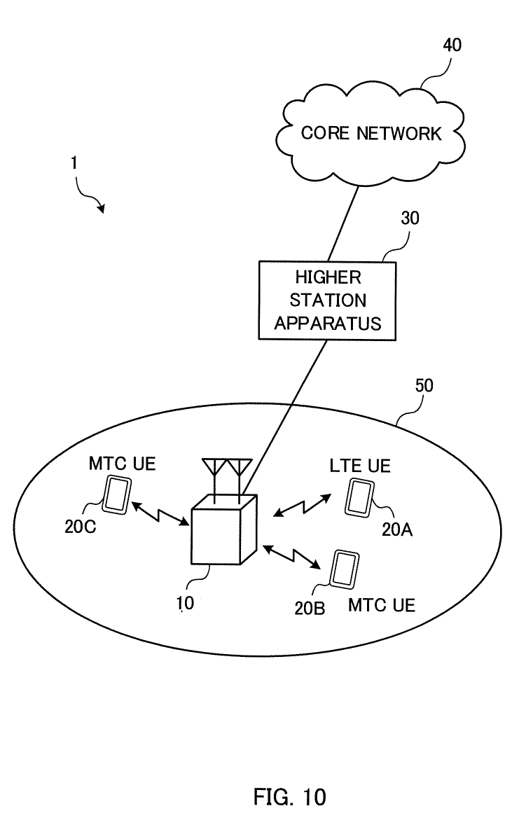

FIG. 10 is a diagram to show a schematic structure of the radio communication system according to an embodiment of the present invention. The radio communication system 1 shown in FIG. 10 is an example of employing an LTE system in the network domain of a machine communication system. The radio communication system 1 can adopt carrier aggregation (CA) and/or dual connectivity (DC) to group a plurality of fundamental frequency blocks (component carriers) into one, where the LTE system bandwidth constitutes one unit. Also, although, in this LTE system, the system band is configured to maximum 20 MHz in both the downlink and the uplink, this configuration is by no means limiting. Note that the radio communication system 1 may be referred to as “SUPER 3G,” “LTE-A,” (LTE-Advanced), “IMT-Advanced,” “4G” (4th generation mobile communication system), “5G” (5th generation mobile communication system), “FRA” (Future Radio Access) and so on.

The radio communication system 1 is comprised of a radio base station 10 and a plurality of user terminals 20A, 20B and 20C that are connected with the radio base station 10. The radio base station 10 is connected with a higher station apparatus 30, and connected with a core network 40 via the higher station apparatus 30. Note that the higher station apparatus 30 may be, for example, an access gateway apparatus, a radio network controller (RNC), a mobility management entity (MME) and so on, but is by no means limited to these.

A plurality of user terminal 20A, 20B and 20C can communicate with the radio base station 10 in a cell 50. For example, the user terminal 20A is a user terminal that supports LTE (up to Rel-10) or LTE-Advanced (including Rel-10 and later versions) (hereinafter referred to as an “LTE terminal”), and the other user terminals 20B and 20C are MTC terminals that serve as communication devices in machine communication systems. Hereinafter the user terminals 20A, 20B and 20C will be simply referred to as “user terminals 20,” unless specified otherwise.

Note that the MTC terminals 20B and 20C are terminals that support various communication schemes including LTE and LTE-A, and are by no means limited to stationary communication terminals such electric meters, gas meters, vending machines and so on, and can be mobile communication terminals such as vehicles. Furthermore, the user terminals 20 may communicate with other user terminals 20 directly, or communicate with other user terminals 20 via the radio base station 10.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, the MIB (Master Information Blocks) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. An MPDCCH is frequency-division-multiplexed with the PDSCH and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. The PUSCH may be referred to as an uplink data channel. User data and higher layer control information are communicated by the PUSCH. Also, downlink radio quality information (CQI: Channel Quality Indicator), delivery acknowledgment information (ACKs/NACKs) and so on are communicated by the PUCCH. By means of the PRACH, random access preambles for establishing connections with cells are communicated.

Note that the channels for MTC terminals may be shown with an “M,” and, for example, MPDCCH, PDSCH, PUCCH, PUSCH for MTC terminals may be referred to as “MPDCCH,” “MPDSCH,” “MPUCCH,” and “MPUSCH,” respectively.

In the radio communication systems 1, cell-specific reference signals (CRSs), channel state information reference signals (CSI-RSs), demodulation reference signal (DMRSs) and so on are communicated as downlink reference signals. Also, in the radio communication system 1, measurement reference signals (SRSs: Sounding Reference Signals), demodulation reference signals (DMRSs) and so on are communicated as uplink reference signals. Note that the DMRSs may be referred to as “user terminal-specific reference signals” (UE-specific reference signals). Also, the reference signals to be communicated are by no means limited to these.

(Radio Base Station)

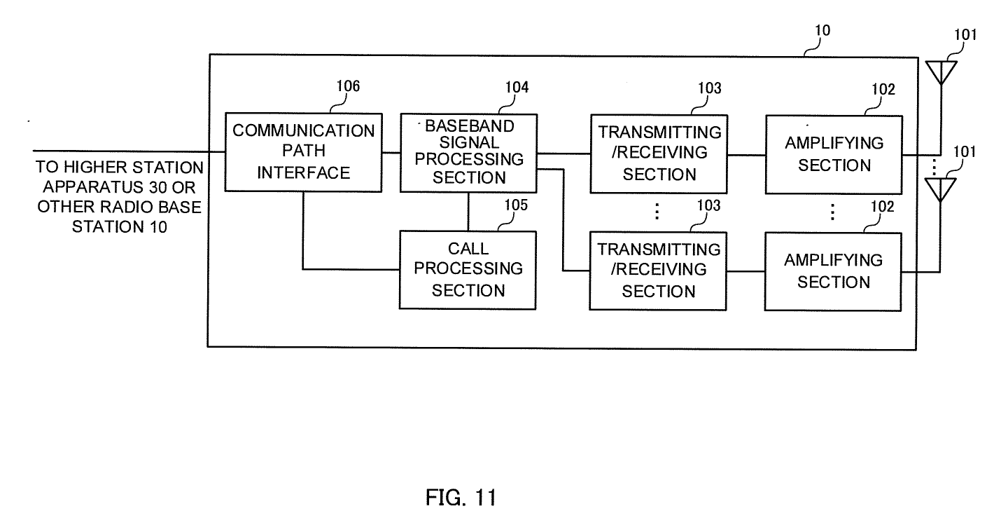

FIG. 11 is a diagram to show an example of an overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as an RLC retransmission control transmission process, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an, inverse fast Fourier transform, and forwarded to each transmitting/receiving section 103.

Each transmitting/receiving section 103 converts baseband signals that are pre-coded and output from the baseband signal processing section 104 on a per antenna basis, into a radio frequency band. The transmitting/receiving sections 103 can be constituted by transmitters/receivers, transmitting/receiving circuits or transmitting/receiving devices that can be described based on common understanding of the technical field to which the present invention pertains. Note that a transmitting/receiving section 103 may be structured as a transmitting/receiving section in one entity, or may be constituted by a transmitting section and a receiving section.

The radio frequency signals having been subjected to frequency conversion in the transmitting/receiving sections 103 are amplified in the amplifying sections 102, and transmitted from the transmitting/receiving antennas 101. The transmitting/receiving sections 103 can transmit and/or receive various signals in a narrow bandwidth (for example, 1.4 MHz) that is more limited than a system band (for example, one component carrier).

Meanwhile, as for uplink signals, radio frequency signals that are received in the transmitting/receiving antennas 101 are each amplified in the amplifying sections 102. Each transmitting/receiving section 103 receives uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (for example, an interface in compliance with the CPRI (Common Public Radio Interface) m such as optical fiber, the X2 interface).

The transmitting/receiving sections 103 transmit PDSCHs that are scheduled in DL NBs, MPDCCHs that contain DCI, and so on, to the user terminal 20. Also, the transmitting/receiving sections 103 transmit information related to the relationship between ARO fields and PUCCH resource index shift amounts, downlink narrow band-specific offsets, PUCCH resource indices, the default values of parameters that are used to determine PUCCH resources, and so on. Also, the transmitting/receiving sections 103 receive PDSCH-related HARQ-ACKs from the user terminal 20.

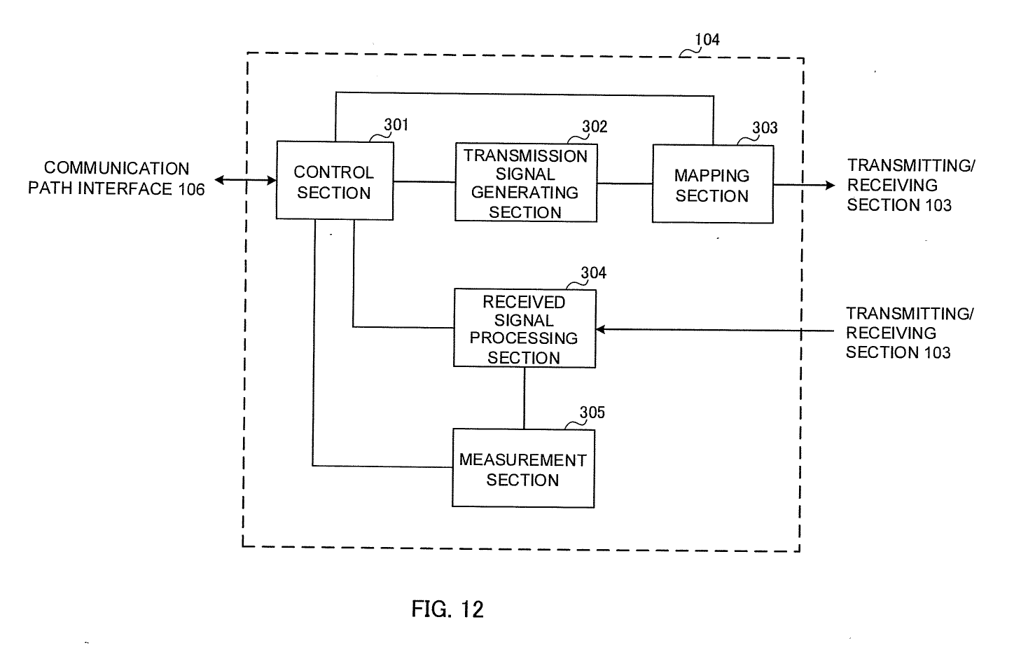

FIG. 12 is a diagram to show an example of functional structure of a radio base station according to one embodiment of the present invention. Note that, although FIG. 12 primarily shows functional blocks that pertain to characteristic parts of the present embodiment, the radio base station 10 has other functional blocks that are necessary for radio communication as well. As shown in FIG. 12, the baseband signal processing section 104 has a control section (scheduler) 301, a transmission signal generating section (generation section) 302, a mapping section 303, a received signal processing section 304 and a measurement section 305.

The control section (scheduler) 301 controls the whole of the radio base station 10. The control section 301 can be constituted by a controller, a control circuit or a control device that can be described based on common understanding of the technical field to which the present invention pertains.

The control section 301, for example, controls the generation of signals in the transmission signal generating section 302, the allocation of signals by the mapping section 303, and so on. Furthermore, the control section 301 controls the signal receiving processes in the received signal processing section 304, the measurements of signals in the measurement section 305, and so on.

The control section 301 controls the scheduling (for example, resource allocation) of downlink data signals that are transmitted in the PDSCH and downlink control signals that are communicated in the PDCCH and/or the MPDCCH. Also, the control section 301 controls the scheduling of downlink reference signals such as synchronization signals (the PSS (Primary Synchronization Signal) and the SSS (Secondary Synchronization Signal)), CRSs, CSI-RSs, DM-RSs and so on.

Also, the control section 301 controls the scheduling of uplink data signals transmitted in the PUSCH, uplink control signals transmitted in the PUCCH and/or the PUSCH (for example, delivery acknowledgement signals (HARQ-ACKs)), random access preambles transmitted in the PRACH, uplink reference signals and so on.

The control section 301 controls the transmission signal generating section 302 and the mapping section 303 to allocate various signals to narrow bands and transmit these to the user terminals 20. For example, the control section 301 controls downlink broadcast information (the MIB, SIBs (MTC-SIBs), etc.), the MPDCCH, the PDSCH and so on to be transmitted in narrow bands.

Also, the control section 301 transmits PDSCHs to the user terminals 20 in predetermined narrow bands. Note that, when the radio base station 10 employs coverage enhancement, for example, the control section 301 may configure a repetition factor for a DL signal for a predetermined user terminal 20, and transmit the DL signal in repetitions based on this repetition factor. Furthermore, the control section 301 may control information about the repetition factor to be reported to the user terminal 20 in a control signal (DCI) in the MPDCCH or by using higher layer signaling (for example, RRC signaling, broadcast information, etc.).

Also, the control section 301 may control so that information about the relationship between downlink narrow bands and uplink narrow bands is generated and reported to the user terminal 20. Also, the control section 301 may control so that information about the relationship between ARO fields for use for the user terminal 20 and the amounts of shift to apply to PUCCH resource indices, information about downlink narrow band-specific offsets, information about PUCCH resource indices and suchlike information are generated and reported to the user terminal 20, so that the PUCCH resources to use for DL NB HARQ-ACK feedback vary per DL NB.

The transmission signal generating section 302 generates downlink signals (downlink control signals, downlink data signals, downlink reference signals and so on) based on commands from the control section 301, and outputs these signals to the mapping section 303. The transmission signal generating section 302 can be constituted by a signal generator, a signal generating circuit or a signal generating device that can be described based on common understanding of the technical field to which the present invention pertains.

For example, the transmission signal generating section 302 generates DL assignments, which report downlink signal allocation information, and UL grants, which report uplink signal allocation information, based on commands from the control section 301. Also, the downlink data signals are subjected to a coding process and a modulation process, based on coding rates and modulation schemes that are determined based on channel state information (CSI) from each user terminal 20 and so on.

Also, when repetitious transmission of a downlink signal (for example, repetitious transmission of the MPDSCH, PDSCH, etc.) is configured, the transmission signal generating section 302 generates the same downlink signal over a plurality of subframes and outputs these signals to the mapping section 303.

The mapping section 303 maps the downlink signals generated in the transmission signal generating section 302 to predetermined narrow band radio resources (for example, maximum 6 resource blocks) based on commands from the control section 301, and outputs these to the transmitting/receiving sections 103. The mapping section 303 can be constituted by a mapper, a mapping circuit or a mapping device that can be described based on common understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control signals, uplink data signals, uplink reference signals and so on). For the received signal processing section 304, a signal processor, a signal processing circuit or a signal processing device that can be described based on common understanding of the technical field to which the present invention pertains can be used.

The received signal processing section 304 applies receiving processes for repeated signals, to the signals received from the user terminals 20 that carry out repetitious signal transmission. The received signal processing section 304 outputs the decoded information acquired through the receiving processes to the control section 301. Also, the received signal processing section 304 outputs the received signals, the signals after the receiving processes and so on, to the measurement section 305.

The measurement section 305 conducts measurements with respect to the received signals. The measurement section 305 can be constituted by a measurer, a measurement circuit or a measurement device that can be described based on common understanding of the technical field to which the present invention pertains.

Also, by using the received signals, the received signal processing section 304 may measure the signal received power (for example, RSRP (Reference Signal Received Power)), the received quality (for example, RSRQ (Reference Signal Received Quality)), channel states and so on. The measurement results may be output to the control section 301.

(User Terminal)

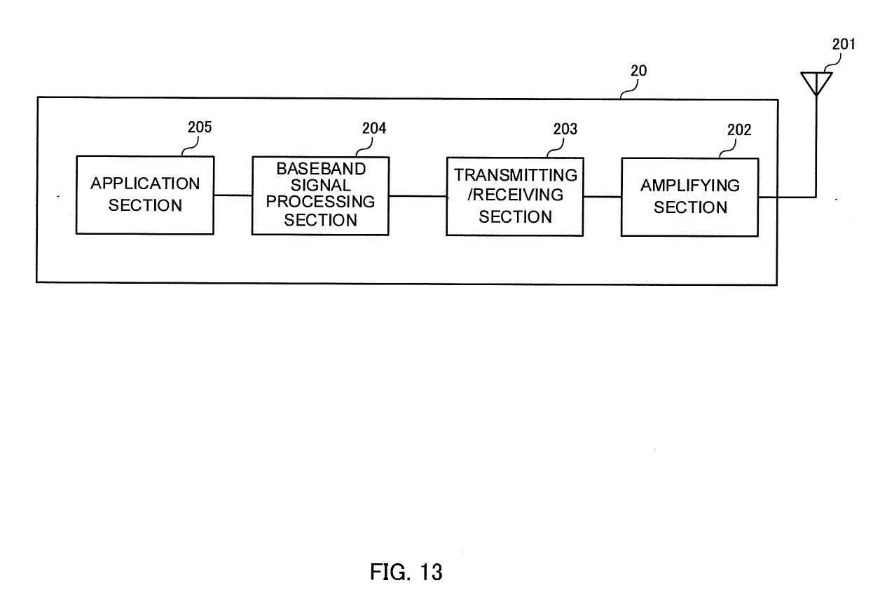

FIG. 13 is a diagram to show an example of an overall structure of a user terminal according to one embodiment of the present invention. Note that, although not described in detail herein, normal LTE terminals may operate to act as MTC terminals. A user terminal 20 has a transmitting/receiving antenna 201, an amplifying section 202, a transmitting/receiving section 203, a baseband signal processing section 204 and an application section 205. Also, the user terminal 20 may have a plurality of transmitting/receiving antennas 201, amplifying sections 202, transmitting/receiving sections 203 and/or others.

A radio frequency signal that is received in the transmitting/receiving antenna 201 is amplified in the amplifying section 202. The transmitting/receiving section 203 receives the downlink signal amplified in the amplifying section 202.

The received signal is subjected to frequency conversion and converted into the baseband signal in the transmitting/receiving section 203, and output to the baseband signal processing section 204. The transmitting/receiving section 203 can be constituted by a transmitters/receiver, a transmitting/receiving circuit or a transmitting/receiving device that can be described based on common understanding of the technical field to which the present invention pertains. Note that the transmitting/receiving section 203 may be structured as a transmitting/receiving section in one entity, or may be constituted by a transmitting section and a receiving section.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to the transmitting/receiving section 203.

The baseband signal that is output from the baseband signal processing section 204 is converted into a radio frequency bandwidth in the transmitting/receiving section 203. The radio frequency signal that is subjected to frequency conversion in the transmitting/receiving section 203 is amplified in the amplifying section 202, and transmitted from the transmitting/receiving antenna 201.

The transmitting/receiving section 203 transmits HARQ-ACKs that pertain to PDSCHs that have been received, to the radio base station, in PUCCHs. Also, the transmitting/receiving section 203 receives PDSCHs that are scheduled in DL NBs, MPDCCHs that contain DCI, and so on, from the radio base station 10. Also, the transmitting/receiving section 203 receives information related to the relationship between ARO fields and PUCCH resource index shift amounts, information related to downlink narrow band-specific offsets, information related to PUCCH resource indices, information related to the default values of parameters that are used to determine PUCCH resources, and so on.

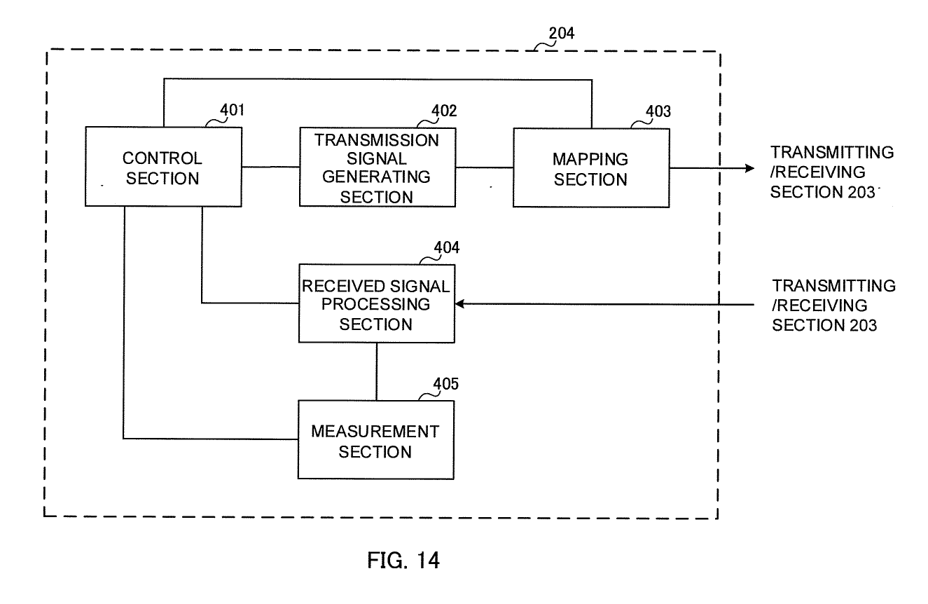

FIG. 14 is a diagram to show an example of a functional structure of a user terminal according to one embodiment of the present invention. Note that, although FIG. 14 primarily shows functional blocks that pertain to characteristic parts of the present embodiment, the user terminal 20 has other functional blocks that are necessary for radio communication as well. As shown in FIG. 14, the baseband signal processing section 204 provided in the user terminal 20 has a control section 401, a transmission signal generating section (generation section) 402, a mapping section 403, a received signal processing section 404 and a measurement section 405.

The control section 401 controls the whole of the user terminal 20. For the control section 401, a controller, a control circuit or a control device that can be described based on common understanding of the technical field to which the present invention pertains can be used.

The control section 401, for example, controls the generation of signals in the transmission signal generating section 402, the allocation of signals by the mapping section 403, and so on. Furthermore, the control section 401 controls the signal receiving processes in the received signal processing section 404, the measurements of signals in the measurement section 405, and so on.

The control section 401 acquires the downlink control signals (signals transmitted in PDCCH/MPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not re transmission control is necessary for the downlink data signals, and so on.

Also, if the repetition factor for an uplink signal (for example, the PUCCH and/or the PUSCH) is configured in the user terminal 20, the control section 401 controls so that signals carrying the same information are transmitted in repetitions over a plurality of subframes, based on information about the repetition level of a predetermined signal.

When information to indicate whether operation is in normal coverage mode or in coverage enhancement mode is input from the received signal processing section 404, the control section 401 can identify the subject terminal's mode based on this information. Also, the control section 401 may judge this mode based on the information about the repetition level.

Also, the control section 401 controls the selection of PUCCH resources. To be more specific, the control section 401 controls PUCCH resources by using PDSCH PRB indices (first embodiment). For example, the control section 401 determines the PUCCH resources to use to transmit ACKs/NACKs in response to PDSCHs received in the received signal processing section 404, based on predetermined rules that link between PDSCH PRB indices and PUCCH resources (for example, PUCCH PRB indices) on a one-to-one basis.

Also, the control section 401 determines the UL NBs for PUCCHs based on the DL NBs in which PDSCHs are received (second embodiment). The control section 401 may determine UL NBs for PUCCHs based on information about the relationship between downlink narrow bands and uplink narrow bands.

Also, the control section 401 controls PUCCH resources to be different per PDSCH-receiving DL NB (third embodiment). For example, the control section 401 may apply frequency shift to PUCCH resources based on the ARO field contained in DCI input from the received signal processing section 404. Also, the control section 401 may apply frequency shift to PUCCH resources based on NB-specific offsets. Furthermore, the control section 401 may apply frequency shift to PUCCH resources based on information related to PUCCH resource indices, input from the received signal processing section 404, and the ARI field contained in DCI.

Note that, the control section 401 may control so that, different DL NBs, the PUCCH resources that correspond to PDSCHs and that are specified by using the same PRB index are 6 PRBs or more different.

The transmission signal generating section 402 generates uplink signals (uplink control signals, uplink data signals, uplink reference signals and so on) based on commands from the control section 401, and outputs these signals to the mapping section 403. The transmission signal generating section 402 can be constituted by a signal generator, a signal generating circuit or a signal generating device that can be described based on common understanding of the technical field to which the present invention pertains.

For example, the transmission information generating section 402 generates uplink control signals such as delivery acknowledgement signals (HARQ-ACKs), channel state information (CSI) and so on, based on commands from the control section 401. Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal.

Also, when the user terminal 20 is configured to transmit a predetermined uplink signal in repetitions, the transmission signal generating section 402 generates the same uplink signal over a plurality of subframes, and outputs these signals to the mapping section 403. The repetition factor may be increased and/or decreased based on commands from the control section 401.

The mapping section 403 maps the uplink signals generated in the transmission signal generating section 402 to radio resources (maximum 6 resource blocks) based on commands from the control section 401, and outputs these to the transmitting/receiving sections 203. The mapping section 403 can be constituted by a mapper, a mapping circuit or a mapping device that can be described based on common understanding of the technical field to which the present invention pertains.

The received signal processing section 404 performs receiving processes (for example, demapping, demodulation, decoding and so on) of received signals that are input from the transmitting/receiving section 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or a signal processing device that can be described based on common understanding of the technical field to which the present invention pertains.

The received signal processing section 404 applies receiving processes for repeated signals to signals received from the radio base stations 10 that carry out repetitious signal transmission. For example, the received signal processing section 404 may perform the DCI (MPDCCH) decoding process by using predetermined identifiers, based on commands from the control section 401.

The received signal processing section 404 output the decoded information that is acquired through the receiving processes to the control section 401. The received signal processing section 404 outputs, for example, broadcast information, system information, RRC signaling, DCI and so on, to the control section 401. Also, the received signal processing section 404 outputs the received signals, the signals after the receiving processes and so on to the measurement section 405.

The measurement section 405 conducts measurements with respect to the received signals. The measurement section 405 can be constituted by a measurer, a measurement circuit or a measurement device that can be described based on common understanding of the technical field to which the present invention pertains.

The measurement section 405 may measure, for example, the received power (for example, RSRP), the received quality (for example, RSRQ), the channel states and so on of the received signals. The measurement results may be output to the control section 401.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or wire and using these multiple devices.

For example, part or all of the functions of radio base stations 10 and user terminals 20 may be implemented using hardware such as an ASIC (Application-Specific Integrated Circuits), a PLD (Programmable Logic Devices), an FPGA (Field Programmable Gate Arrays), and so on. Also, the radio base stations 10 and user terminals 20 may be implemented with a computer device that includes a processor (CPU), a communication interface for connecting with networks, a memory and a computer-readable storage medium that holds programs. That is, the radio base stations and user terminals according to an embodiment of the present invention may function as computers that execute the processes of the radio communication method of the present invention.

Here, the processor and the memory are connected with a bus for communicating information. Also, the computer-readable recording medium is a storage medium such as, for example, a flexible disk, an opto-magnetic disk, a ROM (Read Only Memory), an EPROM (Erasable Programmable ROM), a CD-ROM (Compact Disc-ROM), a RAM (Random Access Memory), a hard disk and so on. Also, the programs may be transmitted from the network through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes.

Here, these programs have only to be programs that make a computer execute each operation that has been described with the above embodiments. For example, the control section 401 of the user terminals 20 may be stored in the memory and implemented by a control program that operates on the processor, and other functional blocks may be implemented likewise.

Also, software and commands may be transmitted and received via communication media. For example, when software is transmitted from a website, a server or other remote sources by using wired technologies such as coaxial cables, optical fiber cables, twisted-pair cables and digital subscriber lines (DSL) and/or wireless technologies such as infrared radiation, radio and microwaves, these wired technologies and/or wireless technologies are also included in the definition of communication media.

Note that the terminology used in this description and the terminology that is needed to understand this description may be replaced by other terms that convey the same or similar meanings. For example, “channels” and/or “symbols” may be replaced by “signals” (or “signaling”). Also, “signals” may be “messages.” Furthermore, “component carriers” (CCs) may be referred to as “carrier frequencies,” “cells” and so on.

Also, the information and parameters described in this description may be represented in absolute values or in relative values with respect to a predetermined value, or may be represented in other information formats. For example, radio resources may be specified by indices.

The information, signals and/or others described in this description may be represented by using a variety of different technologies. For example, data, instructions, commands, information, signals, bits, symbols and chips, all of which may be referenced throughout the description, may be represented by voltages, currents, electromagnetic waves, magnetic fields or particles, optical fields or photons, or any combination of these.

The example s/embodiments illustrated in this description may be used individually or in combinations, and the mode of may be switched depending on the implementation. Also, a report of predetermined information (for example, a report to the effect that “X holds”) does not necessarily have to be sent explicitly, and can be sent implicitly (by, for example, not reporting this piece of information).

Reporting of information is by no means limited to the example s/embodiments described in this description, and other methods may be used as well. For example, reporting of information may be implemented by using physical layer signaling (for example, DCI (Downlink Control Information) and UCI (Uplink Control Information)), higher layer signaling (for example, RRC (Radio Resource Control) signaling, MAC (Medium Access Control) signaling, and broadcast information (MIB (Master Information Block) and SIBs (System Information Blocks))), other signals or combinations of these. Also, RRC signaling may be referred to as “RRC messages,” and can be, for example, an RRC connection setup message, RRC connection reconfiguration message, and so on.

The examples/embodiments illustrated in this description may be applied to LTE (Long Term Evolution), LTE-A (LTE-Advanced), SUPER 3G, IMT-Advanced, 4G, 5G, FRA (Future Radio Access), CDMA 2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), and other adequate systems, and/or next-generation systems that are enhanced based on these.

The order of processes, sequences, flowcharts and so on that have been used to describe the examples/embodiments herein may be re-ordered as long as inconsistencies do not arise. For example, although various methods have been illustrated in this description with various components of steps in exemplary orders, the specific orders that illustrated herein are by no means limiting.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining example s, and should by no means be construed to limit the present invention in any way.

The disclosure of Japanese Patent Application No. 2015-159997, filed on Aug. 13, 2015, including the specification, drawings and abstract, is incorporated herein by reference in its entirety.

1. A user terminal, in which a band to use is limited to a partial narrow band in a system band, the user terminal comprising:
a receiving section that receives a downlink shared channel that is scheduled in a downlink narrow band;
a control section that determines a radio resource for an uplink control channel based on the downlink shared channel; and
a transmission section that transmits the uplink control channel in the radio resource,
wherein the control section determines the radio resource for the uplink control channel so that a different radio resource is determined for each downlink narrow band.

2. The user terminal according to claim 1, wherein the control section determines the radio resource for the uplink control channel based on a PRB index that indicates a PRB (Physical Resource Block) of the downlink shared channel.

3. The user terminal according to claim 1, wherein:
the receiving section receives downlink control information that contains an ARO (ACK/NACK Resource Offset) field; and
the control section shifts the radio resource for the uplink control channel based on the ARO field.

4. The user terminal according to claim 1, wherein the control section shifts the radio resource for the uplink control channel based on a downlink narrow band-specific offset.

5. The user terminal according to claim 1, wherein:
the receiving section receives information related to a PUCCH resource index, and downlink control information that contains an ARI (ACK/NACK Resource Indicator) field; and
the control section determines the radio resource for the uplink control channel based on the information related to the PUCCH resource index and the ARI field.

6. The user terminal according to claim 1, wherein the control section determines radio resources for the uplink control channel for a plurality of downlink narrow bands so that radio resources for the uplink control channel corresponding to a same PRB index are 6 PRBs or more different.

7. The user terminal according to claim 1, wherein the receiving section receives information related to an initial value of a parameter that is used to determine the radio resource for the uplink control channel from a broadcast signal.

8. A radio base station that communicates with a user terminal, in which a band to use is limited to a partial narrow band in a system band, the radio base station comprising:
a transmission section that transmits a downlink shared channel that is scheduled in a downlink narrow band; and
a receiving section that receives the uplink control channel in a radio resource that is determined based on the downlink shared channel,
wherein the radio resource for the uplink control channel is determined so that a different radio resource is determined for each downlink narrow band.

9. A radio communication method for a user terminal, in which a bandwidth to use is limited to a reduced bandwidth in a system bandwidth, the radio communication method comprising the steps of:
receiving a downlink shared channel that is scheduled in a downlink narrow band;
determining a radio resource for an uplink control channel based on the downlink shared channel; and
transmitting the uplink control channel in the radio resource,
wherein the radio resource for the uplink control channel is determined so that a different radio resource is determined for each downlink narrow band.

10. (canceled)

11. The user terminal according to claim 2, wherein:
the receiving section receives downlink control info′ nation that contains an ARO (ACK/NACK Resource Offset) field; and
the control section shifts the radio resource for the uplink control channel based on the ARO field.

12. The user terminal according to claim 2, wherein the control section shifts the radio resource for the uplink control channel based on a downlink narrow band-specific offset.

13. The user terminal according to claim 3, wherein the control section shifts the radio resource for the uplink control channel based on a downlink narrow band-specific offset.

14. The user terminal according to claim 2, wherein the control section determines radio resources for the uplink control channel for a plurality of downlink narrow bands so that radio resources for the uplink control channel corresponding to a same PRB index are 6 PRBs or more different.

15. The user terminal according to claim 3, wherein the control section determines radio resources for the uplink control channel for a plurality of downlink narrow bands so that radio resources for the uplink control channel corresponding to a same PRB index are 6 PRBs or more different.

16. The user terminal according to claim 4, wherein the control section determines radio resources for the uplink control channel for a plurality of downlink narrow bands so that radio resources for the uplink control channel corresponding to a same PRB index are 6 PRBs or more different.

17. The user terminal according to claim 5, wherein the control section determines radio resources for the uplink control channel for a plurality of downlink narrow bands so that radio resources for the uplink control channel corresponding to a same PRB index are 6 PRBs or more different.

18. The user terminal according to claim 2, wherein the receiving section receives information related to an initial value of a parameter that is used to determine the radio resource for the uplink control channel from a broadcast signal.

19. The user terminal according to claim 3, wherein the receiving section receives information related to an initial value of a parameter that is used to determine the radio resource for the uplink control channel from a broadcast signal.

20. The user terminal according to claim 4, wherein the receiving section receives information related to an initial value of a parameter that is used to determine the radio resource for the uplink control channel from a broadcast signal.

21. The user terminal according to claim 5, wherein the receiving section receives information related to an initial value of a parameter that is used to determine the radio resource for the uplink control channel from a broadcast signal.
